(19) United States
(12) Patent Application Publication
(10) Pub. No.: US 2007/0195715 A1
(43) Pub. Date: Aug. 23, 2007

(54) Communications apparatus, communications system, and communication method

(75) Inventors: Satoru Yamano, Tokyo (JP); Hideaki Tani, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/706,185

(22) Filed: Feb. 15, 2007

(30) Foreign Application Priority Data
Feb. 17, 2006 (JP) 2006-041004

(51) Int. Cl. H04L 12/28; H04L 12/56

(52) U.S. Cl. 370/254; 370/400

(57) ABSTRACT

In a network made up of a plurality of devices each capable of a multi-hop communication that conforms to at least one of the wired communication standards or wireless communication standards, each device monitors a communication situation on communication links and path established between the device and a destination device. When the communication situation changes, the device switches the communication path for use in a communication with the destination device to another communication path which can be established between the device and destination device.

This application is based upon and claims the benefit of priority from Japanese Patent Application No. 2006-041004 filed on Feb. 17, 2006, the content of which is incorporated by reference.

### BACKGROUND OF THE INVENTION

1. Field of the Invention

The present invention relates to a communications apparatus, a communications system, and a communication method which are suitable for home networks, PAN (Personal Area Network), and ad-hoc networks, each made up of a plurality of devices connected in conformance with a variety of communication standards, such as wired links, wireless links and the like.

2. Description of the Related Art

In recent years, investigations have been made to connect personal computers, portable telephones, information home electric appliances, AV (Audio and Visual) devices and the like with network related devices to build networks in order to more effectively provide users with functions of these devices.

On the other hand, a variety of communication standards are available to these devices, and include, for example, Ethernet, IEEE1394, power line communication and the like, which are classified as wired communication standards, and wireless LAN, Bluetooth, UWB (Ultra Wide Band) and the like, which are classified as the wireless communication standards.

For building a network using a plurality of devices conforming to a variety of communication standards, it is important to eliminate complicated operations made by the user for setting, management and the like of communication paths to improve the usability. The plug-and-play is a conventionally known technique for addressing this challenge.

For example, a network can be built in a plug-and-play mode using devices conforming to IEEE1394 which is an interface standard currently used mainly in AV devices (see IEEE Std 1394-1995, IEEE Standard for a High Performance Serial Bus). IEEE1394 defines two types of data transfer modes: a synchronous transfer mode and an asynchronous transfer mode, and audio, moving image and the like can be communicated in real time by supporting QoS (Quality of Service) in the synchronous transfer mode. However, IEEE1394 only defines lower layers, and has a problem that IEEE1394-based devices cannot basically be interconnected with devices which have link layers other than those conforming to IEEE1394.

Accordingly, UPnP (Universal Plug and Play) has been proposed for enabling the interconnection of devices conforming to a variety of communication standards in the plug-and-play mode (see UPnP Forum, [searched on Jan. 24, 2007], Internet <URL:http://www.upnp.org/resources/documents.asp>). According to UPnP, respective devices can automatically interconnect to each other to build a network, and to provide their respective functions to one another. However, UPnP defines specifications which relate only to upper layers, allow anything to be used for the link layer, and are intended to simply implement connections between devices. As such, UPnP fails to consider QoS (Quality of Service) and the like for satisfying a communication bandwidth, a delay and the like required by each device. For this reason, UPnP is not suited to real-time communications of audio, moving images and the like under a wireless environment or under a network environment in which wired devices are mixed with wireless devices.

As described above, among conventional communications systems, a communication standard which only defines lower layers, such as IEEE1394, can support QoS for communications between devices while implementing plug-and-play, but has a problem that the same communication standard can only be applied.

On the other hand, a communication standard which only defines upper layers, such as UPnP, cannot support QoS for communications between devices although it can build a network in the plug-and-play mode. This leads to a problem of the inability to accommodate real-time communications of audio, moving images and the like in a heterogeneous network in which wired devices are mixed with wireless devices.

### SUMMARY OF THE INVENTION

It is therefore an object of the present invention to provide a communications apparatus, a communications system, and a communication method which are capable of supporting real-time communication of audio, moving images and the like while realizing plug-and play even in a heterogeneous network in which wired devices are mixed with wireless devices.

To achieve the above object, in the present invention, a network is made up of a plurality of devices, each of which is capable of a multi-hop communication conforming to at least one of the wired communication standards and wireless communication standards, wherein each device monitors a communication situation on communication links and path established between the devices and a destination device, and when the communication situation changes, the device switches the communication path for use in communication with the destination device to another communication path which can be established between the device and destination device. Accordingly, plug-and-play can be accomplished even under a heterogeneous network environment in which devices conforming to wired communication standards are mixed with devices conforming to wireless communication standards. Also, since an optimal communication path can be selected in consideration of QoS even if a communication situation changes between devices, the present invention can support real-time communication of audio, moving images and the like.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a schematic diagram illustrating an exemplary configuration of a network in which wired links are mixed with wireless links;

FIG. 2 is a block diagram illustrating an exemplary configuration of an end device and a link device shown in FIG. 1;

FIG. 3 is a state transition diagram representing operation states of the end device and link device shown in FIG. 1;

FIG. 4 is a schematic diagram illustrating how the devices shown in FIG. 1 are connected after links have been established;

FIG. 5 is a table showing an exemplary link database shown in FIG. 2;

FIG. 6 is a table showing an exemplary device database shown in FIG. 2;

FIG. 7 is a flow chart illustrating a processing procedure performed by each of the end devices and link devices shown in FIG. 1;

FIG. 8 is a flow chart illustrating a procedure of a link search process shown in FIG. 7;

FIG. 9 is a flow chart illustrating a procedure of an information exchange process shown in FIG. 7;

FIG. 10 is a flow chart illustrating a procedure of a communication path building process and a procedure of safeguarding the built communication paths within a path management process shown in FIG. 7;

FIG. 11 is a flow chart illustrating a procedure of a communication path switching process within the path management process shown in FIG. 7;

FIG. 12 is a table showing an exemplary device database contained in each of the link devices and end devices in a second embodiment;

FIG. 13 is a schematic diagram illustrating the network configuration in a first example of a communications system according to the present invention;

FIG. 14 is a table showing an exemplary link database built by an end device which has been added to the network illustrated in FIG. 13;

FIG. 15 is a table showing an exemplary device database immediately after communication is started by an end device which has been added to the network illustrated in FIG. 13;

FIG. 16 is a sequence diagram illustrating the operation of the respective devices shown in FIG. 13;

FIG. 17 is a schematic diagram illustrating the network configuration in a second example of the communications system according to the present invention;

FIG. 18 includes tables showing exemplary link databases built by the end devices and link devices after switching to a second communication path shown in FIG. 17;

FIG. 19 is a table showing an exemplary device database built by the end devices and link devices shown in FIG. 17;

FIG. 20 is a sequence diagram illustrating the operation of the respective devices in the second example of the communications system according to the present invention;

FIG. 21 is a schematic diagram illustrating the network configuration in a third example of the communications system according to the present invention;

FIG. 22 is a table showing an exemplary link database which is built by a link device added to the network illustrated in FIG. 21 after a link has been found;

FIG. 23 is a table showing an exemplary device database which has been built before a link device is added to the network illustrated in FIG. 21;

FIG. 24 is a sequence diagram illustrating the operation of the respective devices in the third example of the communications system according to the present invention;

FIG. 25 is a schematic diagram illustrating the network configuration in a fourth example of the communications system according to the present invention;

FIG. 26 is a table showing an exemplary device database before a reservation of first traffic, after the reservation of the first traffic, and after a reservation of second traffic; and

FIG. 27 is a sequence diagram illustrating the operation of the respective devices shown in FIG. 25.

### DETAILED DESCRIPTION OF THE PREFERRED EMBODIMENTS

### First Embodiment

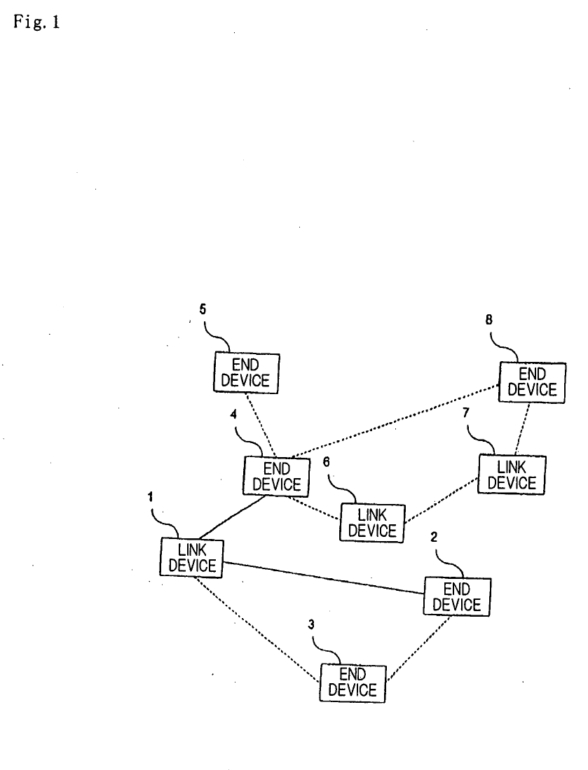

As illustrated in FIG. 1, devices (communications apparatus) which make up a network are generally classified into an end device and a link device. The end device refers to a device by which the user implements desired functions, such as a personal computer, a portable telephone, an information home electric appliance, an AV device and the like. The link device refers to a network related device for relaying communications between devices, such as a router, HUB and the like. In FIG. 1, solid lines represent wired links, while dotted lines represent wireless links. Each of the end devices and link devices comprises a communications interface unit for communicating with another device through a wired link or a wireless link. The link device comprises a function for implementing a communication relay, i.e., a multi-hop communication. A communication interface unit contained in the end device may also provide such a function.

Each of the end devices and link devices transmits/receives user data to/from each device through a plurality of links on the network by its own communications interface unit. Assume in the present invention that the addressing of each device has been solved, and information for identifying each device (for example, an IP address) has been previously assigned to each device.

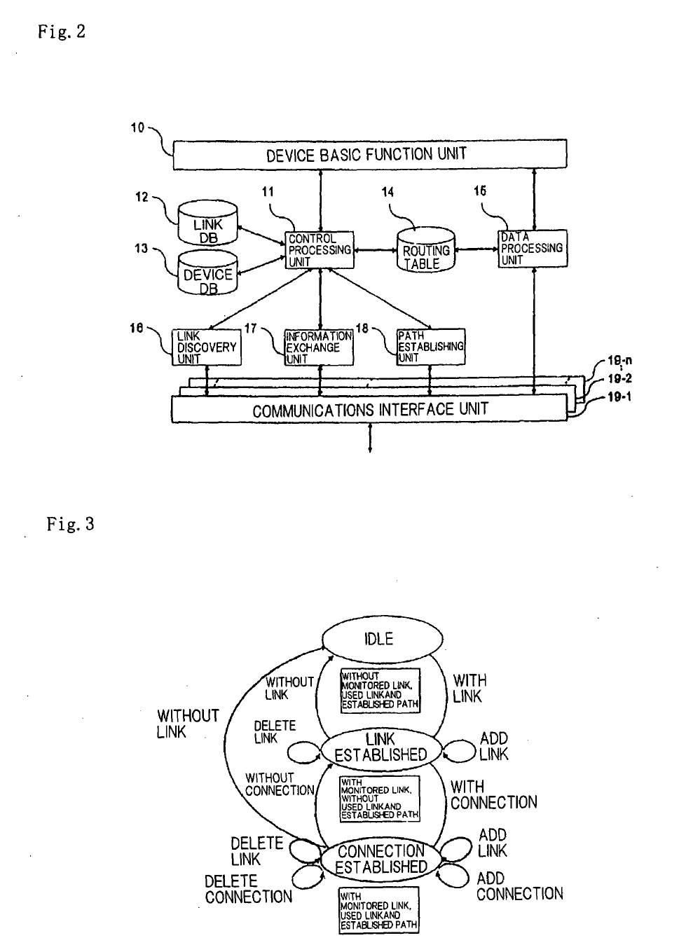

As illustrated in FIG. 2, each of the end devices and link devices comprises device basic function unit 10 for providing basic functions of the device except for communication functions; a plurality of communication interface units 19-1-19-n (n is a positive integer) for communicating with other devices; link discovery unit 16 for acquiring link information required to establish a link with another device; information exchange unit 17 for exchanging information on each device on the network (device information), link information and the like; path establishing unit 18 for establishing and managing a communication path between devices; link database (link DB) 12 for storing link information acquired by link discovery unit 16; device database (device DB) 13 for storing device information acquired by information exchange unit 17; routing table 14 for storing information on communication paths between devices, which are created based on link database 12 and device database 13; control processing unit 11 for controlling the operation of link discovery unit 16, information exchange unit 17, path establishing unit 18, link database 12, device database 13, and routing table 14; and data processing unit 15 for controlling transmission/reception of data between communications interface units 19-1-19-n and device basic function unit 10. Link discovery unit 16, information exchange unit 17, path establishing unit 18, control processing unit 11, and data processing unit 15 may be configured using, for example, logic circuits, memories and the like, respectively, or may comprise a CPU (or a DSP) and a recording medium, where the CPU (or DSP) executes processing of each component described below in accordance with a program stored in the recording medium.

As illustrated in FIG. 3, the end device and link device have three operation states: an idle state, a link establishing state, and a connection established state. The idle state refers to a state in which a device cannot yet find a wired link or a wireless link and has not established a link with another device, and has not established a communication path. The link establishing state refers to a state in which a device is monitoring one or more wired links or wireless links found thereby, and has established a link with a neighboring device, but has not established a communication path with each device. The connection established state refers to a state in which a device is monitoring one or more wired links or wireless links found thereby, and has established a link with a neighboring device as well as a communication path with each device through an arbitrary link.

Each of the end device and link device transitions to the link establishing state when there is no longer any communication path in the connection established state, and transitions to the idle state when there is no longer any link with another device. In addition, each of the end devices and link devices transition to the idle state when there is no longer any link with another device in the connection established state.

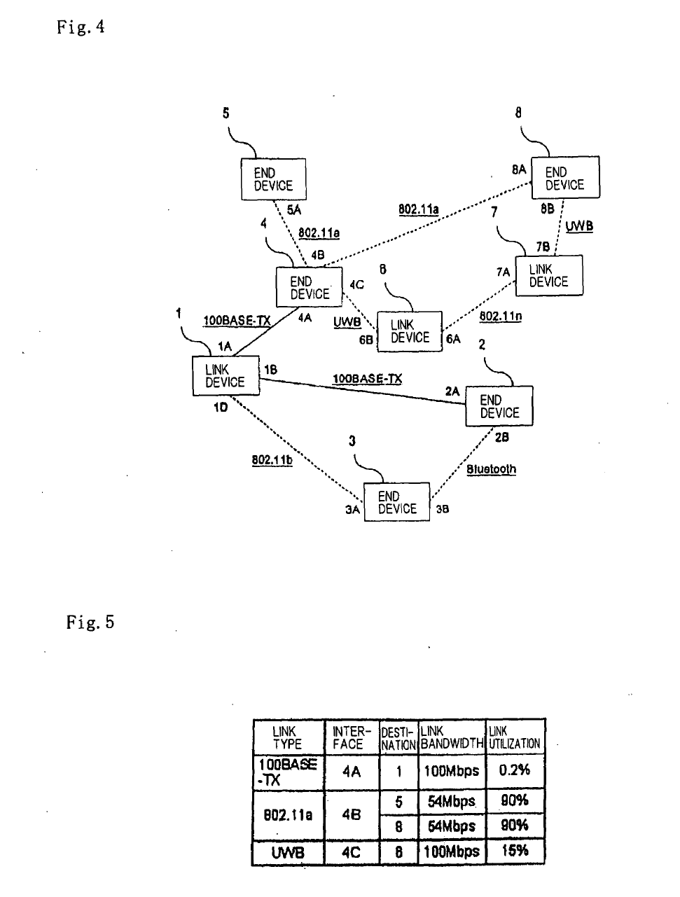

FIG. 4 illustrates the network after links have been established between respective devices shown in FIG. 1. FIG. 4 indicates the types of respective links established between respective devices (100BASE-TX, 802.11a/b/n, Bluetooth, UWB, and the like) and interface identification IDs assigned to the respective devices. The interface identification ID is information for uniquely identifying at least one communications interface unit contained in each device, and an IP address, a MAC address or the like, for example, is used for the interface identification ID.

FIG. 5 shows an example of the link database shown in FIG. 2. FIG. 5 shows an example of link database 12 contained in end device 4 shown in FIG. 4.

As shown in FIG. 5, link database 12 stores such information as the type of a communication standard used by communication interface 19-n of the device, the interface identification ID, a device identification ID of a linked destination, a link bandwidth indicative of a physical bandwidth available for transmission/reception on the link, and a link utilization indicative of a used bandwidth of the link taking into account overhead such as a header, packet retransmission, radio frequency interference and the like. The device identification ID is information for uniquely identifying a device, and an IP address, a MAC address or the like, for example, are used for the device identification ID. The link utilization is represented by the percentage of a used bandwidth to a link bandwidth on a certain link. For example, a used bandwidth on a wired link is equal to the total traffic amount including overhead such as a header. On the other hand, a used bandwidth on a wireless link is the sum of the traffic amount including overhead such as a header taking into account effective rate, and the amount of consumed bandwidth due to radio frequency interference.

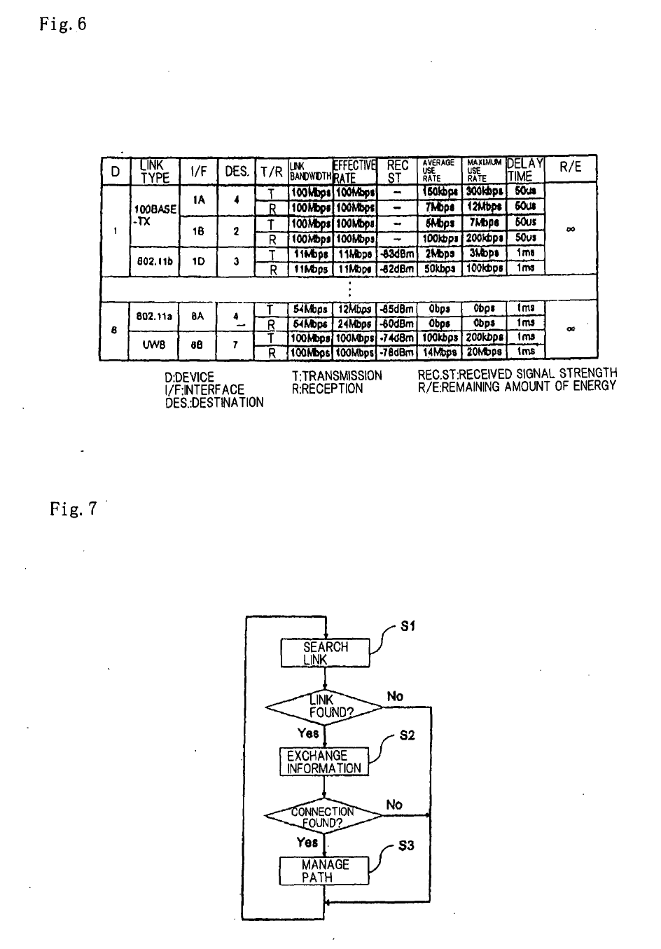

FIG. 6 shows an example of the device database shown in FIG. 2. FIG. 6 shows an example of device database 13 contained in each device shown in FIG. 4.

As shown in FIG. 6, device database 13 stores such information as a device identification ID, a link type, an interface identification ID, a device identification ID of a destination, link bandwidths on the transmission and reception sides, an effective rate which indicates an actual communication rate (on a wireless link, the effective rate varies depending on a particular radiowave environment), a received signal strength measured when a radiowave is received on a wireless link, an average use rate and a maximum use rate at which a wired link or a wireless link is occupied (here including overhead such as a header), a delay time on a link and within a device, a remaining amount of energy in the device (for example, the amount of remaining battery), and the like.

As illustrated in FIG. 7, each of the end devices and link devices comprises a link search process (step S1) for searching for a device which can be linked with the device itself, an information exchange process (step S2) for exchanging link information, device information and the like with a linked device, and a path management process (step S3) for building, switching, and managing communication paths between respective devices. Each of the end devices and link devices repeatedly executes these three processes. Each of the end devices and link devices executes the link search process once more when the link search process results in a failure to find any device to which it can be linked. In addition, each of the end devices and link devices executes the link search process and information exchange process once more when the information exchange process results in a failure to find a communication path for communicating with each device.

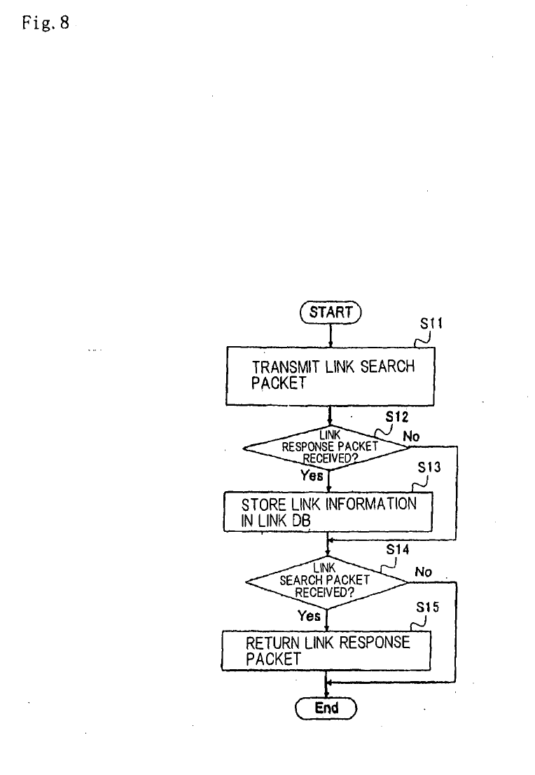

As illustrated in FIG. 8, in the link search process, each device broadcasts a link search packet from all of its communications interface units 19, respectively, in order to determine whether or not there is a neighboring device to which it can link (step S11). After finding a device to which a link can be formed, the link search packet can be utilized to monitor the link to the device as well.

Each device determines whether or not it has received a link response packet including link information which contains a link type, a link bandwidth, a device identification ID, a link utilization and the like from a neighboring device (step S12), and extracts the link information from the link response packet for storage in link database (link DB) 12 when the device has received the link response packet (step S13).

Next, each device determines whether or not it has received a link search packet (step S14), and returns a link response packet including the link information to a device which has transmitted the link search packet, when the device has received the link search packet (step S15).

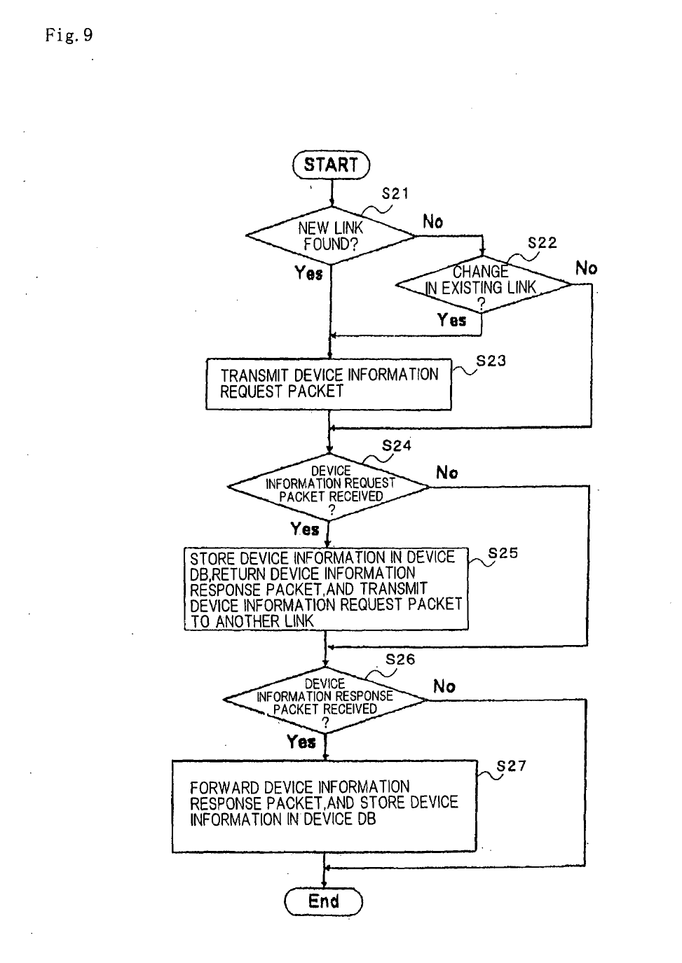

As illustrated in FIG. 9, in the information exchange process, each device first determines whether or not a new link has been found in the link search process (step S21), and determines whether or not a change has been sensed on an existing link when no new link is found (step S22).

When a new link has been found, or when a change has been sensed on an existing link, the device transmits a device information request packet to each link (step S23). In this event, latest device information of the device itself is contained in the device information request packet. The device information request packet is transmitted for acquiring device information of a device located next on each link onward, and device information on each device connected further from that next device onward, and for notifying the device information of the device itself to other devices.

Next, each device determines whether or not it has received a device information request packet (step S24). When the device information request packet has been received, the device extracts device information from the device information request packet, and updates device database (device DB) 13 based on the device information. Then, the device sends a device information response packet including device information on each device, stored in the device itself, back to the source device, and transmits a device information request packet to other links (step S25). In this event, the latest device information of the device itself is contained in the device information request packet.

Then, each device determines whether or not it has received a device information response packet including device information (step S26), and forwards the device information response packet to a device which first transmitted the device information request packet after the device has received the device information response packet. Then, the device extracts device information from the device information response packet, and updates device database (device DB) 13 based on the device information (step S27).

It should be noted that each packet has been previously assigned, for example, a predefined sequence number, time stamp or the like so as not to permanently continue the transmission/reception operation of the same device information request packet and device information response packet between the respective devices. When the device receives a packet having the same contents, the device discards this packet or corresponding obsolete device information.

The path management process is divided into a communication path building process, a process for safeguarding built communication paths, and a communication path switching process.

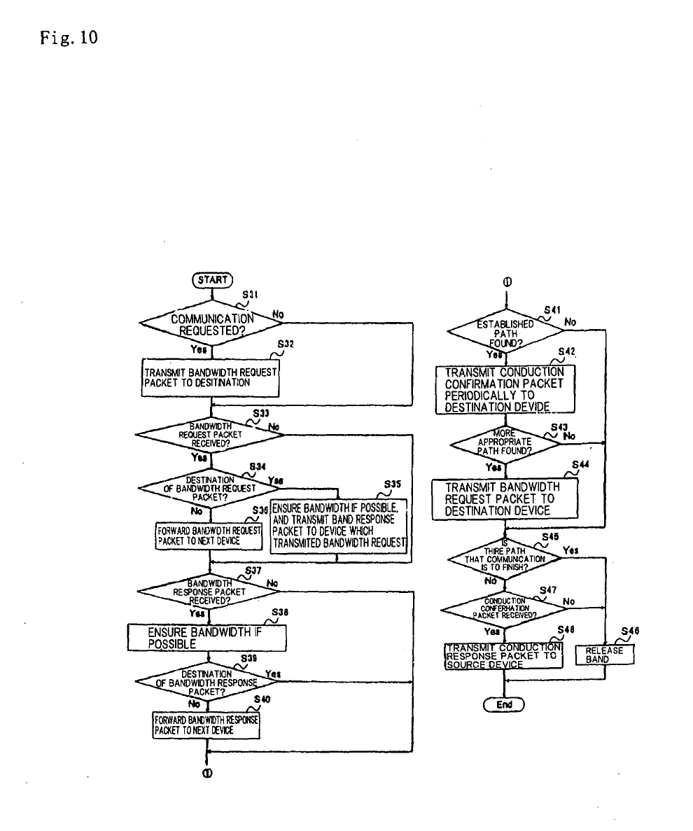

First, the communication path building process and the process for safeguarding built communication paths will be described with reference to FIG. 10.

As illustrated in FIG. 10, control processing unit 11 of each device determines whether or not a communication request has been made from device basic function unit 10 for a predetermined device (step S31). When device basic function unit 10 requests control processing unit 11 for communication with another device, control processing unit 10 transmits a bandwidth request packet to a device for which communication has been requested (hereinafter called the “destination device”) in order to ensure communication quality that is required by an application currently executed by device basic function unit 10 (step S32). A method of determining a communication path to the destination device may involve source routing in which a communication path is determined by the source device based on the link information, device information, and requested bandwidth, or may involve distribution routing in which a communication path is determined by a relay device located between the source device and destination device based on the link information, device information, and requested bandwidth. In the present invention, either of the two options may be employed for the routing method.

Each device determines whether or not it has received a bandwidth request packet (step S33), and determines whether or not the device itself is the destination device of the bandwidth request packet (step S34) when it has received the bandwidth request packet. When the device itself is the destination device of the bandwidth request packet, the device confirms whether or not a required bandwidth can be saved, saves the bandwidth if possible, and then transmits a bandwidth response packet, including information which indicates that the bandwidth has been saved, back to the source device (step S35). When the device itself is not the destination device of the bandwidth request packet, the device forwards the bandwidth request packet to the next device connected thereto through the link (step S36).

On the other hand, each device determines whether or not it has received the bandwidth response packet (step S37), confirms whether or not a required bandwidth can be saved when the device has received the bandwidth response packet, and saves the bandwidth if possible (step S38). Then, the device determines whether or not the device itself is the destination device of the bandwidth response packet (step S39). When the device itself is not the destination device of the bandwidth response packet, the device forwards the bandwidth response packet to the next device connected thereto through the link (step S40). When the device itself is the destination device of the bandwidth response packet, the device establishes a communication path between the device itself and the destination device, and transitions to the connection established state.

Next, the process for safeguarding communication paths will be described with reference to FIG. 10.

As illustrated in FIG. 10, the end device or link device determines whether or not there is any previously established communication path (step S41), and periodically transmits a conduction confirmation packet to each destination device through a currently used path, when any previously established path is present, in order to monitor the communication environment associated with each destination device (step S42).

Each device finds a new link or senses a change in an existing link, and determines whether or not there is a more optimal communication path (step S43). Then, when a more optimal communication path is found, the device transmits a bandwidth request packet in order to utilize the optimal communication path even if it is already in communication with the destination device through another communication path (step S44).

Each device determines whether or not there is a communication path on which communication is to finish (step S45), and when the device receives a bandwidth release request packet after communication has finished or cannot receive a conduction confirmation packet within a predetermined time, the device determines that the communication path is unnecessary, and releases the communication bandwidth (step S46).

Also, each device determines whether or not it has received the conduction confirmation packet (step S47), and transmits a conduction response packet, when the device has received the conduction confirmation packet, in order to notify the source device that the currently used path can be normally used (step S48).

Next, the communication path switching process will be described with reference to FIG. 11.

A communication situation can become degraded on a communication path established between a source device and a destination device because of such causes as a reduction in CNR (Carrier to Noise Ratio) and received signal strength due to a change in wireless environment, an oppressed bandwidth due to a lower transmission rate (corresponding to the effective rate) of wireless LAN or the like which supports adaptive modulation, an increase in delay time due to congestion, and the like. Each device monitors a change in the link utilization in order to detect such changes in the communication situation, and acquires information on the link utilization monitored by a destination device by transmitting a link search packet. When the link utilization exceeds a certain threshold, the device switches to a more optimal communication path in order to restrain the occurrence of delay, jitter, and packet loss. A path to be switched may be determined by new device information upon detection of a change in the communication situation, or a spare communication path may be provided beforehand.

As illustrated in FIG. 11, each device calculates the amount of bandwidth in each link that is used based on the effective rate, and determines whether or not the used bandwidth of each link on the previously established existing communication path is small enough to provide a requested bandwidth (step S51). When the used bandwidth of the link is small enough, the device confirms whether or not the received signal strength on each link exceeds a previously set threshold to determine whether or not the received signal strength (reception situation) on each link is sufficient on each existing communication path (step S52). When each link exhibits sufficient received signal strength, each device compares the delay times of each link and end-to-end with a previously set threshold to determine whether or not the delay time of each link is sufficient on each existing communication path (step S53). When the conditions at steps S51-S53 are all satisfied, each device terminates the process without switching the communication path.

When any of the conditions at steps S51-S53 is not satisfied, each device determines whether or not there is another path which satisfies QoS other than the existing communication path (step S54). When there is no candidate path which satisfies QoS other than the existing communication path, the process is terminated without switching the communication path.

On the other hand, when there is a candidate path which satisfies QoS other than the existing communication path, the device determines whether or not there is a candidate link which satisfies the used bandwidth condition (step S55). When such a candidate link is found, the device determines whether or not the candidate link provides sufficient received signal strength (reception situation) (step S56). Also, when the candidate link provides sufficient received signal strength, the device determines whether or not the candidate link has a sufficient delay time (step S57). When the candidate link has a sufficient delay time, the device selects the newly searched communication path as an optimal communication path, and switches to a link which utilizes this communication path (step S58). When there is no candidate link which satisfies the used bandwidth condition, or when the candidate link does not provide sufficient received signal strength, or when the candidate link does not have a sufficient delay time, the device terminates the process without switching the communication path.

When there is a plurality of optimal communication paths, any one may be selected from among them, and paths not selected in this event may be provided as spare communication paths.

### Second Embodiment

A communications system of a second embodiment differs from the communications system of the first embodiment in that traffic can be reserved at an arbitrary time by a bandwidth request packet, and that a priority can be given on traffic. Since the rest of the configuration and processing procedure is similar to those in the first embodiment, a description thereon is omitted.

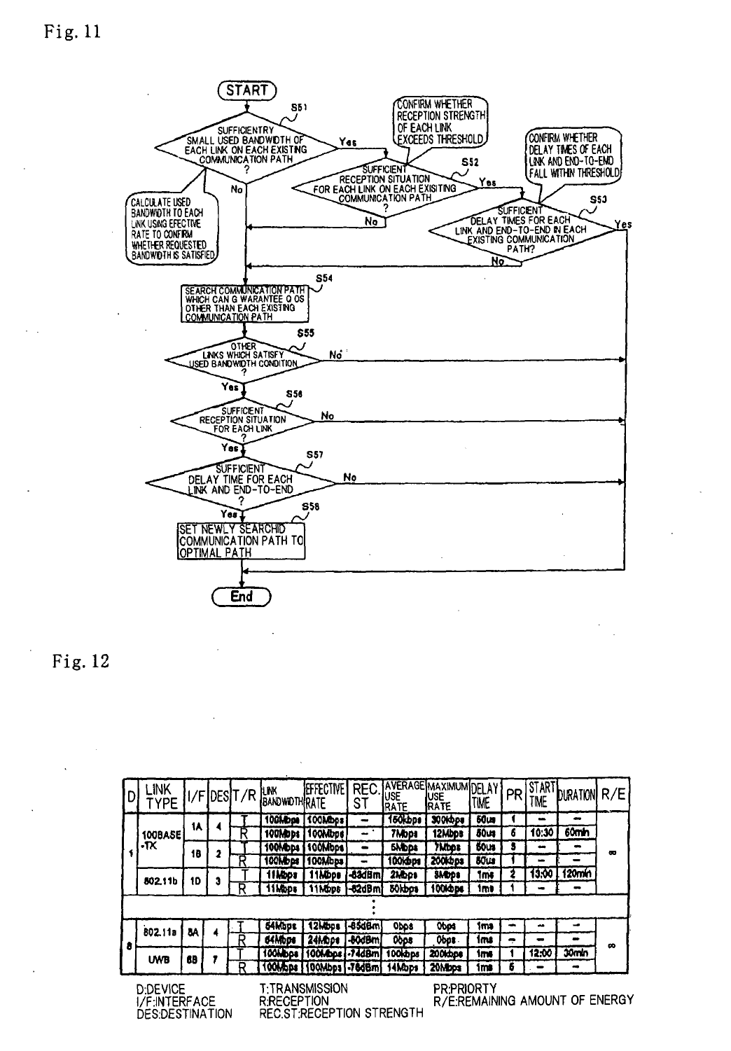

As illustrated in FIG. 12, device database 13 used in the second embodiment stores information based upon prioritizing traffic levels on traffic (a higher value indicates a higher priority), a start time from which a communication path is used, and a duration indicative of a time period for which the communication path is used, in addition to the device database used in the first embodiment shown in FIG. 6. Each device (communications apparatus) comprises such device database 13.

Each device on a communication path on which reserved traffic flows provides notification that a reservation has been made to utilize the communication path at an arbitrary time using a bandwidth request package, and the requesting device is informed through a bandwidth request packet that the reservation for the communication path is completed.

If the reservation for the communication path should be changed due to traffic having a higher priority which is generated after completion of the reservation for the communication path, a release of the reservation for the communication path is requested using a bandwidth release request packet, and the requesting device is informed of the release of the reservation for utilizing the communication path using a bandwidth release response packet. In this connection, link bandwidths between respective devices are desirably spaced by a predetermined amount in order to provide for traffic having higher priorities. In this event, a bandwidth for which a reservation has been made, may be determined individually for each link between respective devices.

### EXAMPLES

Next, several examples of the communications system according to the present invention will be described with reference to the drawings.

### First Example

A first example presents a scenario in which a device is newly added to a network. The following description will be given of a scenario in which end device 3 shown in FIG. 4 is newly added to the network, and end device 3 communicates with end device 4.

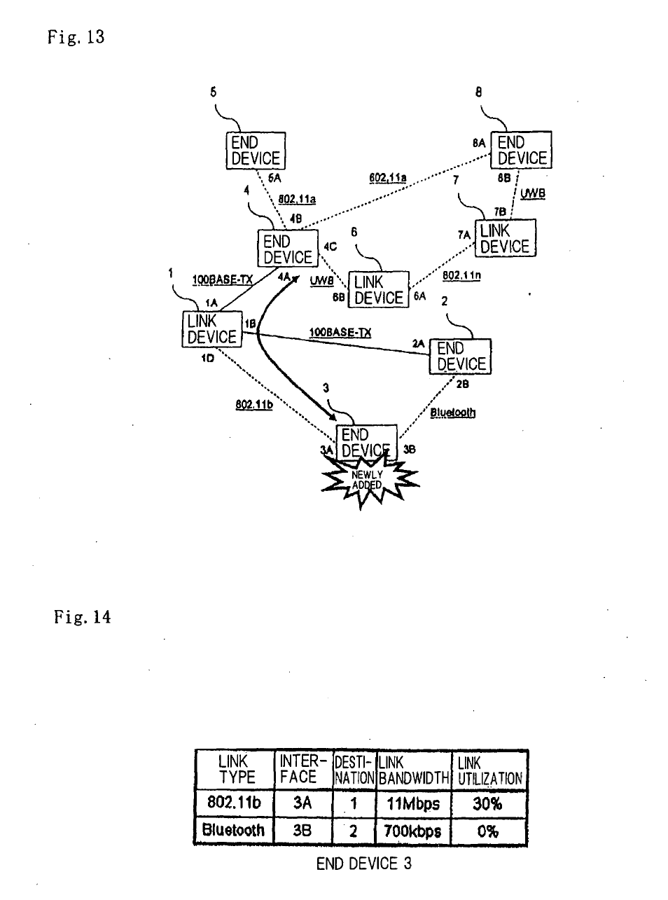

As illustrated in FIG. 13, in the communication system of the first example, end device 3 comprises a communication interfaces unit which supports 802.11b and Bluetooth which are wireless communication standards. Also, end device 3 communicates with end device 4 through link device 1 by routing after it has been added to the network.

FIG. 14 shows an exemplary database built by the end device added to the network shown in FIG. 13.

As shown in FIG. 14, it is understood that end device 3 can communicate with link device 1 in conformance with 802.11b which is a wireless communication standard, and can also communicate with end device 2 in conformance with Bluetooth.

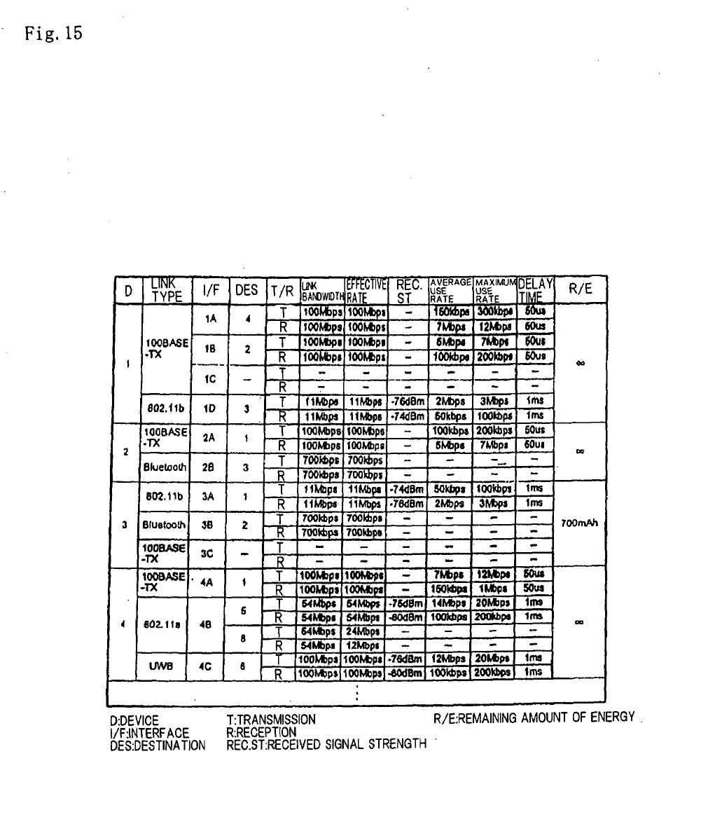

FIG. 15 shows an example of the device database immediately after the end device added to the network shown in FIG. 13 has started a communication.

As shown in FIG. 15, database 13 stores device information on each of communications interface units 19 in all devices, including those communications interface units to which no device is connected. Here, an average use rate is set to 50 kbps when packets are transmitted from end device 3 to end device 4, while an average use rate is set to 2 Mbps when packets are transmitted from end device 4 to end device 3. In the first example, such device database 13 is provided in all devices, but device database 13 may store only device information on those devices to which the device itself can reach through one hop.

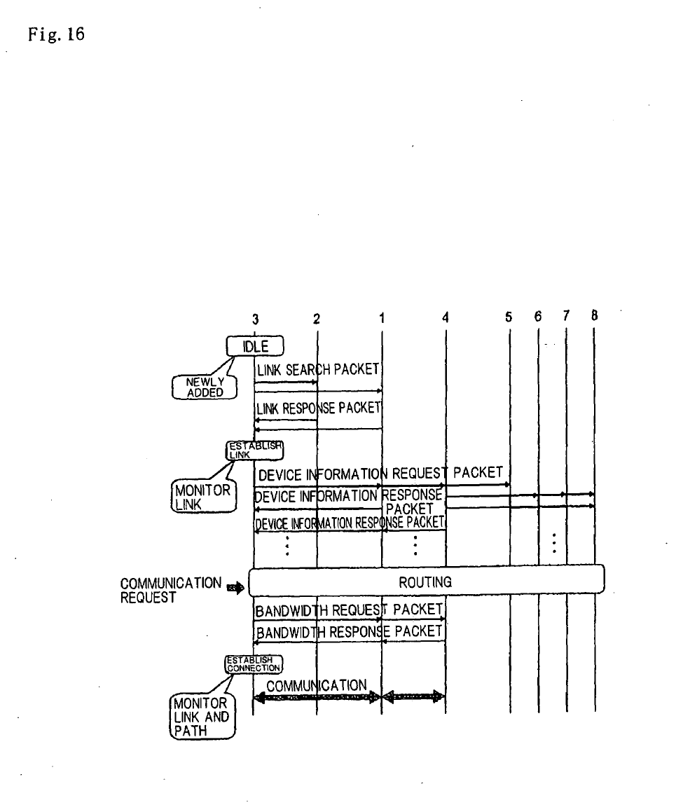

As shown in FIG. 16, end device 3 transitions to the idle state when it is newly added to the network, and broadcasts link search packets from communications interface units conforming to 802.11b and Bluetooth, respectively. Devices (here, link device 1 and end device 2) which receive the link search packets return link response packets, including link information of the devices, to end device 3, respectively.

Upon receipt of the link response packets from link device 1 and end device 2, end device 3 stores link information included therein in link database 12, and establishes links with link device 1 and end device 2. Subsequently, end device 3 monitors the links with these devices. Further, for finding the network topology, end device 3 transmits a device information request packet to link device 1 and end device 2.

Upon receipt of the device information request packet from end device 3, link device 1 and end device 2 transmits a device information request packet to neighboring devices in order to acquire device information on the respective devices. Upon receipt of device information response packets including device information from the neighboring devices, link device 1 and end device 2 updates device database 13 based on the received information. Also, link device 1 and end device 2 reads device information on each device from device data base 13 contained therein, and stores the device information in a device information response packet for transmission to end device 3. When link device 1 or end device 2 contains the database 13 that stores the newest information related to all devices on the network, link device 1 or end device 2 may generate device information on all devices from the information to return the device information to end device 3.

When end device 3 receives, for example, a communication request for end device 4 from device basic function unit 10, end device 3 transmits a bandwidth request packet to end device 3 based on path information stored in routing table 14. In this event, a routing method for determining a communication path to end device 4 may be the aforementioned source routing method or distribution routing method, but end device 3 herein transmits the bandwidth request packet to end device 4 through link device 1.

Upon receipt of the bandwidth request packet from end device 3, end device 4 saves a reservation for a required bandwidth, and returns a bandwidth response packet including information to end device 3 to indicate that a communication path has been saved. Upon receipt of the bandwidth response packet, end device 3 establishes a communication path to end device 4 through link device 1 and transitions to the connection established state. End device 3, link device 1, and end device 4 monitor links with their respective neighboring devices.

### Second Example

A second example presents a scenario in which a communication path established between devices is switched due to a degraded communication situation.

As described above, a communication situation on a communication path established between a source device and a destination device can become degraded as a result of a reduction in CNR and received signal strength due to a change in wireless environment, an oppressed bandwidth due to a lower transmission rate (corresponding to the effective rate) of wireless LAN or the like which supports adaptive modulation, an increase in delay time due to congestion, and the like.

The second example shows a scenario in which a communication path established between devices is switched due to exacerbation the worsening condition of a communication environment (throughput, radiowave received signal strength, SIR (Signal to Interference Signal Power Ratio), delay and the like).

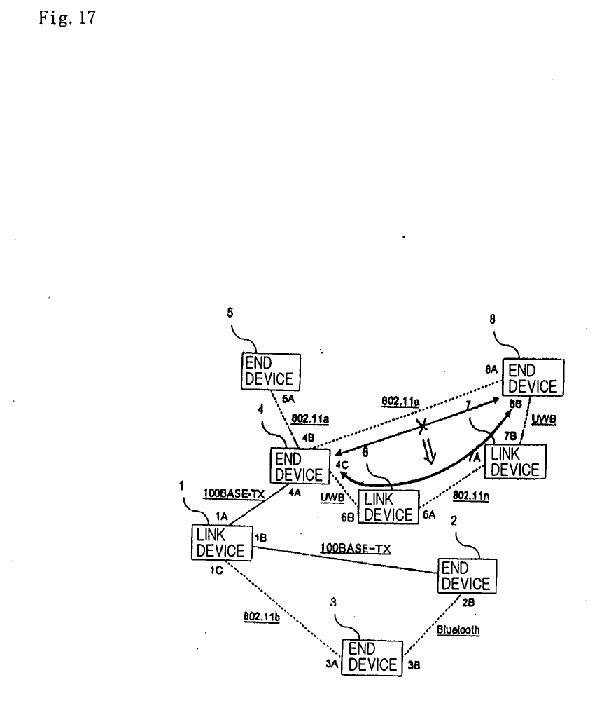

As illustrated in FIG. 17, in the communication system of the second example, a first communication path directly connected in conformance with 802.11a, which is a wireless communication standard, and a second communication path via link device 6 and link device 7 can be established between end device 4 and end device 8. Link device 6 and link device 7 each have communications interface units conforming to 802.11n and UWB which are wireless communication standards. End device 4 and link device 6 are interconnected in conformance with UWB, and end device and link device 7 are interconnected in conformance with UWB as well. Link device 6 and link device 7 in turn are interconnected in conformance with 802.11n. The following description will be given of a scenario in which the first communication path established between end device 4 and end device 8 is switched to the second communication path due to exacerbation of the communication environment around the first communication path.

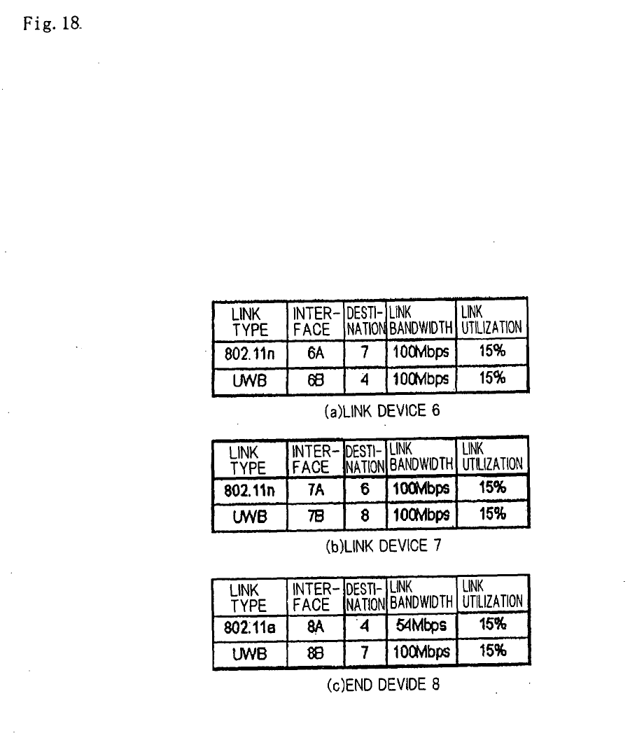

FIG. 18 shows exemplary link databases built by end device and link devices after switching to the second communication path, as illustrated in FIG. 17.

As shown in FIG. 18, it is understood that link device 6 can communicate with link device 7 in conformance with 802.11n which is a wireless communication standard, and can communicate with end device 4 in conformance with UWB. It is also understood that link device 7 can communicate with link device 6 in conformance with 802.11n which is a wireless communication standard, and can communicate with end device 8 in conformance with UWB. It is further understood that end device 8 can communicate with end device 4 in conformance with 802.11a which is a wireless communication standard, and can communicate with link device 7 in conformance with UWB.

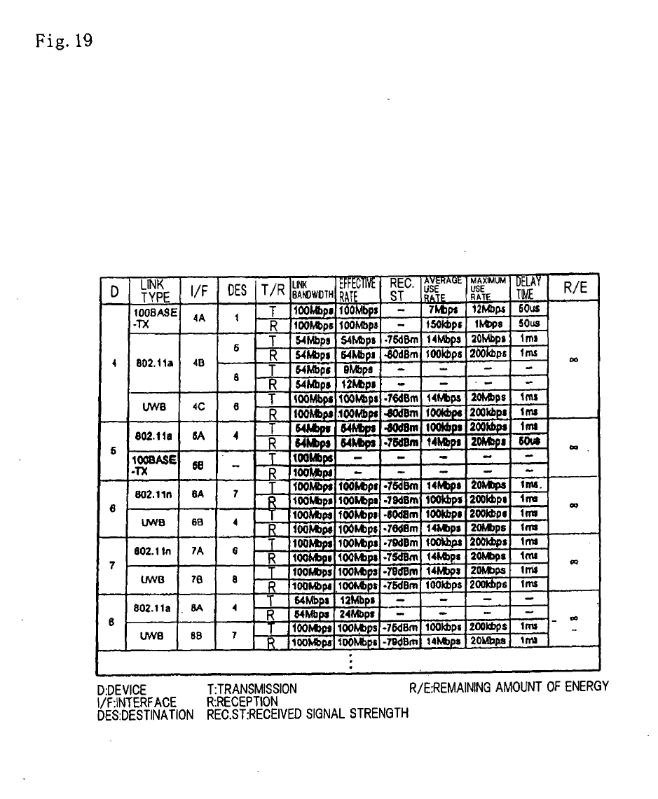

FIG. 19 shows an exemplary device database built by the end device and link device shown in FIG. 17. Specifically, FIG. 19 shows an exemplary device database immediately after end device 8 and end device 4 have switched the communication path.

As shown in FIG. 19, an average use rate is 100 Kbps when packets are transmitted from end device 8 to end device 4 through link devices 7, 6. On the other hand, an average use rate is 14 Mbps when packets are transmitted from end device 4 to end device 8 through link devices 7, 6. Assume in the second example that such device database 13 is contained in all devices. Alternatively, device database 13 may store only device information on those devices to which the device itself can reach through one hop.

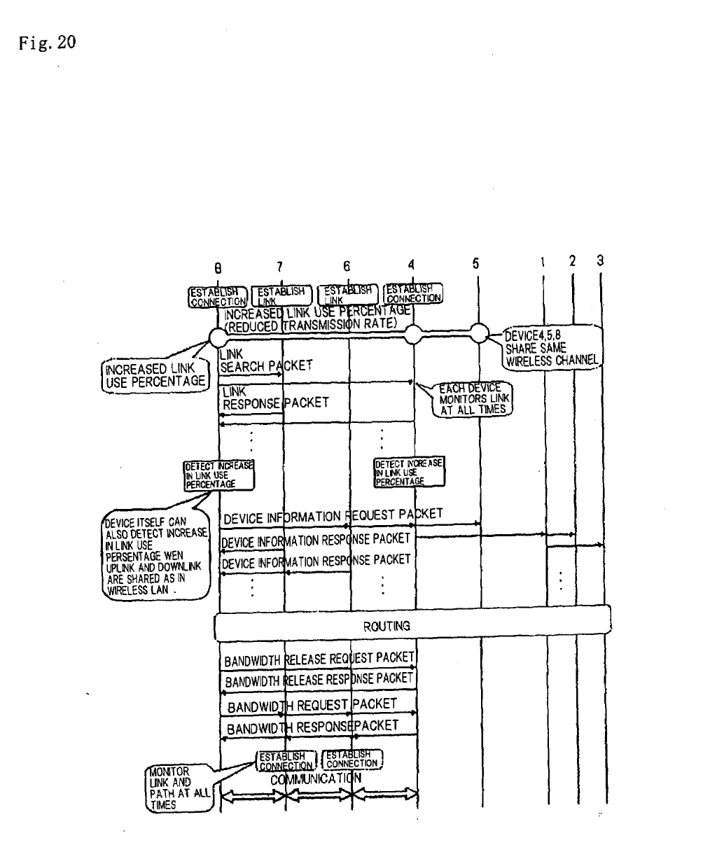

As illustrated in FIG. 20, the first communication path has been established between end device 4 and end device 8. End device 8 and end device 4 are each monitoring a used bandwidth (link utilization) on a link which utilizes the first communication path at all times in accordance with the communication path switching process illustrated in FIG. 11. Then, upon detection of a failure in satisfying the used bandwidth, received signal strength, or delay time condition on the link (here caused by an oppressed wireless bandwidth resulting from a lower transmission rate), a device transmits a link search packet to another neighboring device. For example, when end device 8 detects a change in the link utilization, end device 8 transmits a link search packet to link device 7, and link device 7 returns a link response packet to end device 8.

Upon receipt of the link response packet, end device 8 transmits a device information request packet to link device 7. The device information request packet is forwarded from link device 7 to link device 6, and is further forwarded to end device 4 and end device 5. Device information response packets are sequentially returned from link device 7, link device 6, and end device 4 to end device 8 which has transmitted the device information request packet.

Each device executes a routing process based on updated device information to confirm the existence of the new second communication path via link device 6 and link device 7, which can guarantee required QoS between end device 8 and end device 4. In this connection, when there is no communication path which can guarantee Qos other than the first communication path, the user is notified to that effect.

End device 8 releases the first communication path which directly connects end device 8 to end device 4 by transmitting a bandwidth release request packet to end device 4 through the first communication path and receives a bandwidth release response packet that is returned from end device 4. End device 8 transmits a bandwidth request packet to end device 4 through link device 7 and link device 6.

End device 4 transmits a bandwidth response packet including information which indicates that a reservation for requested bandwidth has been confirmed, to end device 8 which has transmitted the bandwidth request packet, through link device 7 and link device 6. Subsequently, the second communication path is established between end device 8 and end device 4 to make communications therethrough. Here, the first communication path may be released after the second communication path has been established so as to avoid a delay or a packet loss during switching of the communication path, or the second communication path may have been previously established as a spare path.

### Third Example

A third example presents a scenario in which a communication path is switched due to an ameliorated communication path resulting from the addition of a new device to a network.

The following description will be given of a scenario in which link device 6 and link device 7 shown in FIG. 4 are newly added to the network, so that a communication path between end device 4 and end device 8 is switched due to the addition of link device 6 and link device 7.

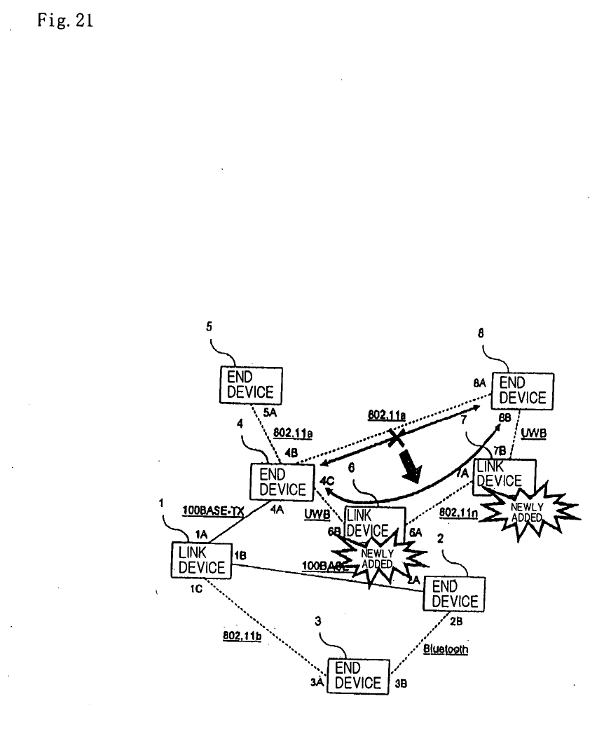

As illustrated in FIG. 21, assume in the communication system of the third example, a first communication path directly connected in conformance with 802.11n, which is a wireless communication standard, has been established between end device 4 and end device 8. Subsequently, the addition of link device 6 and link device 7 results in the establishment of a new second communication path between end device 4 and end device 8 via link device 6 and link device 7.

Link device 6 and link device 7 has communications interface units in conformance with 802.11n and UWB, respectively. End device 4 and link device 6 are communicably interconnected in accordance with UWB, while end device 8 and link device 7 are communicably interconnected in conformance with UWB as well. Link device 6 and link device 7 in turn are communicably interconnected in conformance with 802.11n.

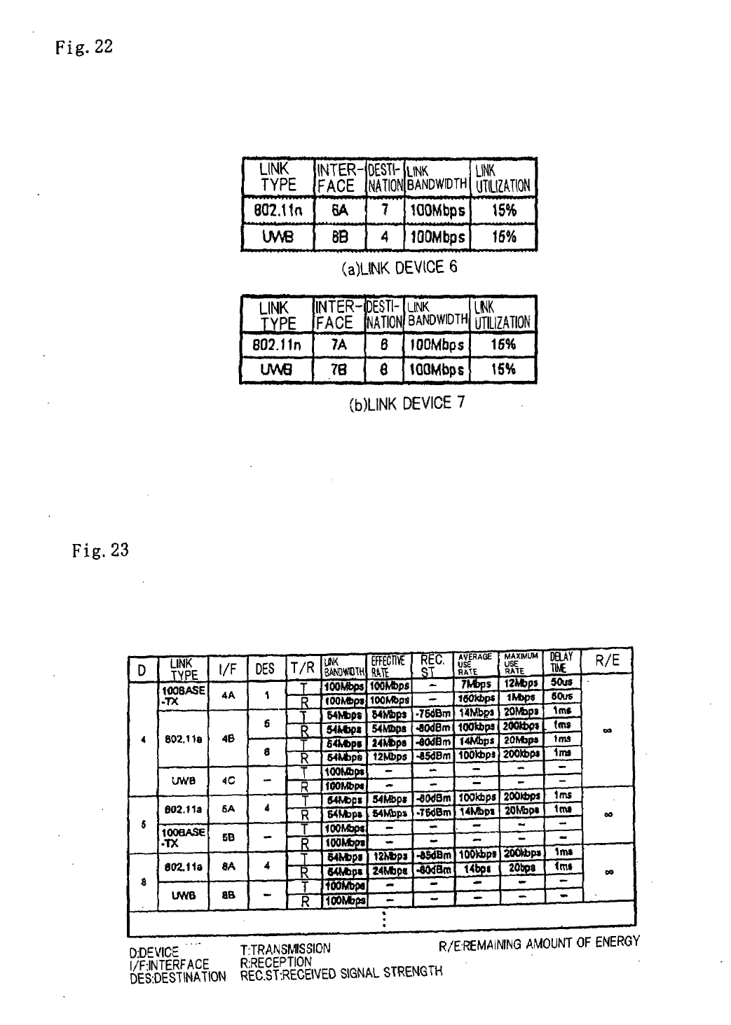

FIG. 22 shows an exemplary link database which is built by the link devices added to the network illustrated in FIG. 21 after a link has been found.

As shown in FIG. 22, it is understood that link device 6 can communicate with link device 7 in conformance with 802.11n, and can communicate with end device 4 in conformance with UWB. It is also understood that link device 7 can communicate with link device 6 in conformance with 802.11n, and can communicate with end device 8 in conformance with UWB.

FIG. 23 shows an exemplary device database which has been built before the link devices were added to the network illustrated in FIG. 21. In this connection, device database 13 similar to that of FIG. 19 is built after link device 6 and link device 7 have been added to the network.

As shown in FIG. 23, database 13 stores device information on each of communications interface units 19 in all devices, including those communications interface units which have no destination. Here, an average use rate is set to 14 Mbps from end device 8 to end device 4, while an average use rate is set to 100 kbps from end device 8 to end device 4. Also, when the first communication path is utilized for communications between end device 8 and end device 4, the effective rate is 12 Mbps for transmission from end device 8 to end device 4, and is 24 Mbps for reception from end device 4 to end device 8. On the other hand, when the second communication path via links 6, 7 is utilized, as shown in FIG. 19, the effective rate is 100 Mbps for transmission from end device 8 to end device 4, and is 100 Mbps for reception from end device 4 to end device 8. Accordingly, it is understood that a better communication environment is provided on the second communication path via link device 6 and link device 7 than the first communication path which directly connects end device 8 to end device 4. While the third example shows that such device database 13 is provided in all devices, device database 13 may store only device information on those devices to which the device itself can reach through one hop.

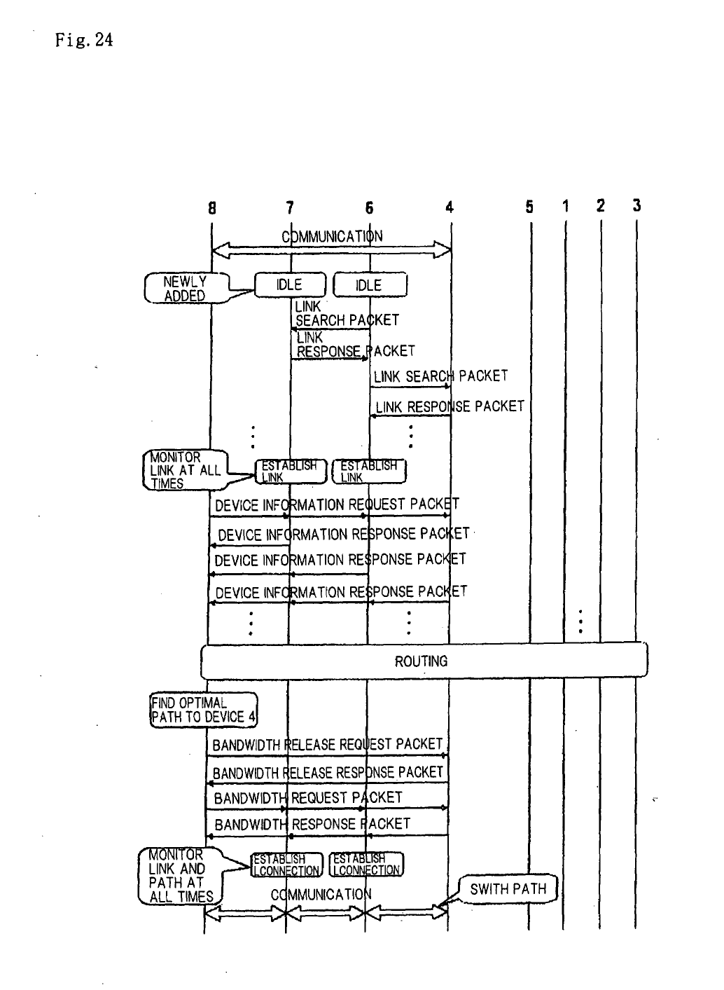

As illustrated in FIG. 24, the first communication path has been established between end device 4 and end device 8. In this state, as link device 6 and link device 7 are added to the network, link device 6 and link device 7 transitions to the idle state, and broadcasts link search packets from all communications interface units 19 contained therein.

Upon receipt of the link search packet, a device returns a link response packet including link information on the device itself to link device 6 and link device 7. End device 8, which has already been in communication with end device 4, first broadcasts a device information request packet when it finds a new link. Upon receipt of the device information request packet, link device 7 stores device information in the device DB, returns a device information response packet to end device 8, and transmits a device information request packet to other links for acquiring device information on each device. The device information request packet is forwarded to link device 6 and end device 4, and device information response packets are transmitted from these devices to end device 8. When a device which has received the device information request packet has device database 13 containing the newest information related to all devices, the device may generate device information on all devices from the latest information and return the generated device information to end device 4.

Subsequently, each device executes a routing process based on updated device information in a manner similar to the second example to confirm the existence of the new second communication path via link device 6 and link device 7, which can guarantee required QoS between end device 8 and end device 4.

End device 8 compares the first communication path with the second communication path in terms of the used bandwidth, reception situation, and delay time based on the updated device information, and releases the first communication path and establishes the second communication path in a manner similar to the second example, when it determines that the second communication path is better. Consequently, end device 8 switches from the first communication path, so far utilized for communications, to the second communication path which provides a better communication environment.

### Fourth Example

A fourth example presents a scenario in which a communication path is switched due to two reservations of traffic which are made with different priorities between end devices.

The following description will be given of a scenario in which after completion of a reservation of first traffic which flows at an arbitrary time between end device 3 and end device 4 shown in FIG. 4, second traffic with a higher priority is generated to flow at the same time between end device 3 and end device 4. Assume herein that higher priority traffic is reserved preferentially over lower priority traffic.

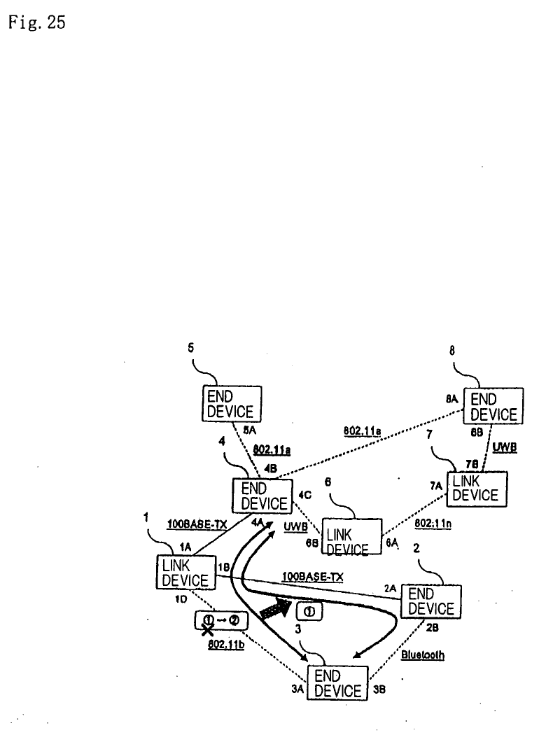

As illustrated in FIG. 25, in a communications system of the fourth example, end device 3 has communications interface units conforming to 802.11b and Bluetooth which are wireless communication standards. End device 2 in turn has a communications interface unit conforming to 100BASE-TX which is a wired communication standard and a communications interface unit conforming to Bluetooth which is a wireless communication standard. Further, link device 1 has a communications interface unit conforming to 100BASE-TX which is a wired communication standard and a communications interface unit conforming to 802.11b which is a wireless communication standard, and end device 4 has a communications interface unit conforming to 100BASE-TX which is a wired communication standard and communications interface units conforming to 802.11a and UWB which are wireless communication standards.

Assume that a first communication path via link device 1 and a second communication path via end device 2 and link device 1 can be established between end device 3 and end device 4.

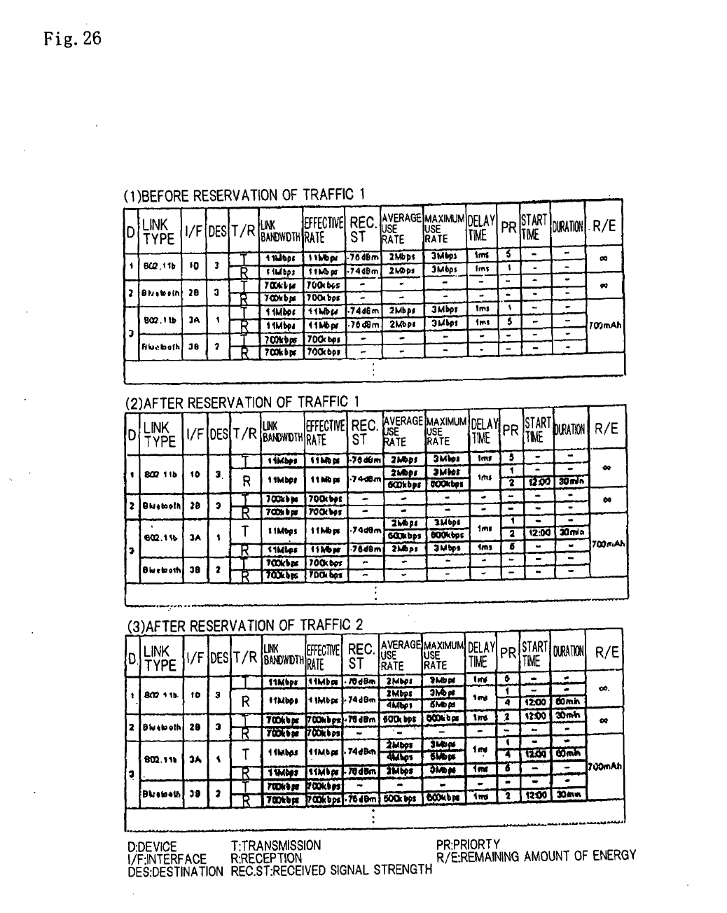

FIG. 26 shows examples of device database 13 before the reservation of the first traffic, after the reservation of the first traffic, and after the reservation of the second traffic.

As shown in FIG. 26, before reserving the first traffic, traffic is flowing from link device 1 to end device 3 at an average use rate of 2 Mbps, while traffic is flowing from end device 3 to link device 1 at an average use rate of 50 kbps.

In this state, the first traffic is reserved from end device 3 to link device 1, utilizing the first communication path, with an average use rate of 500 kbps, a maximum use rate of 600 kbps, a start time at 12:00, duration of 30 minutes, and a priority of two.

Further, after the first traffic has been reserved, the second traffic is reserved from end device 3 to link device 1, utilizing the first communication path, with an average use rate of 4 Mbps, a maximum use rate of 5 Mbps, a start time at 12:00, a duration of 60 minutes, and a priority of four.

In this event, since the link utilization exceeds 100% between end device 3 and link device 1, it is impossible to save the availability of a bandwidth which, will accommodates the maximum use rates at which the first traffic and second traffic are allowed to pass, on a link between end device 3 and link device 1. Likewise, it is impossible to save the availability of a bandwidth, which will accommodates the maximum use rate at which the second traffic is allowed to pass on a link between end device 3 and end device 2.

Accordingly, end device 3 cancels the reservation of the first traffic having lower priority on the first communication path, and reserves the second traffic. Also, end device 3 reserves once more the first traffic on the second communication path via end device 2 and link device 1.

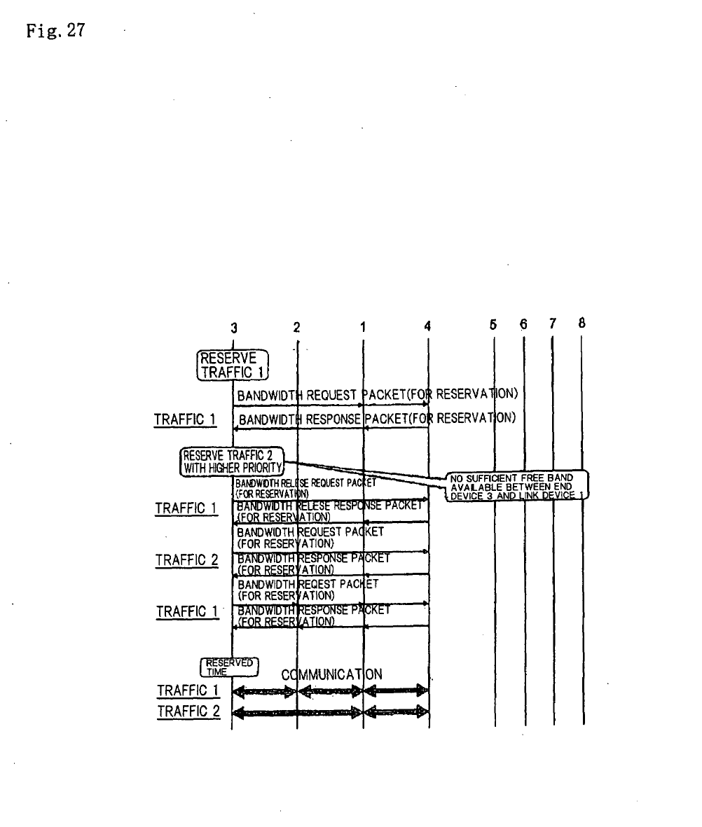

As illustrated in FIG. 27, when end device 3 transmits a bandwidth request packet including first traffic reservation information to link device 1, link device 1 transmits the bandwidth request packet to end device 4. End device 4 returns a bandwidth response packet to the reservation request from end device 3 to link device 1 which in turn transmits the bandwidth response packet to end device 3, thereby reserving the first communication path for the communication of the first traffic.

Subsequently, when the second traffic is to be reserved in end device 3 with a higher priority than the first traffic, end device 3 reserves the first communication path for the communication of the second traffic. However, since the link between end device 3 and link device 1 cannot provide a sufficient bandwidth to pass the first traffic and second traffic, end device 3 transmits a bandwidth release request packet including information that indicates that the reserved first traffic has been released to end device 4 through link device 1. The reservation of the first traffic on the first transmission path is released by returning a bandwidth response packet to the reservation release request from end device to end device 3 through link device 1.

Subsequently, end device 3 reserves the first communication path for the communication of the second traffic in a procedure similar to reservation of the first traffic. Then, end device 3 reserves the second communication path via end device 2 and link device 1, which has a sufficient free bandwidth, for the communication of the first traffic.

As a result, when the reserved time, the first traffic flows on the second communication path via end device 2 and link device 1 from end device 3 to end device 4, while the second traffic flows on the first communication path via link device 1 from end device 3 to end device 4.

While a preferred embodiment of the present invention has been described using specific terms, such description is for illustrative purposes only, and it is to be understood that changes and variations may be made without departing from the spirit or scope of the following claims.

What is claimed is:

1. A communications apparatus for use in a communications system which has a network made up of a plurality of devices each capable of a multi-hop communication conforming to at least one wired communication standards or wireless communication standards, said communications apparatus comprising:
a control processing unit for monitoring a communication situation on communication links and path established between said communication apparatus and a destination communications apparatus, and responsive to a change in the communication situation for switching the communication path for use in a communication with the destination communications apparatus to another communication path which can be established between said communications apparatus and said destination communications apparatus.

2. The communications apparatus according to claim 1, wherein:
said change in the communication situation is new traffic generated on a communication path established between said communications apparatus and said destination communications apparatus.

3. The communications apparatus according to claim 1, wherein:
said change in the communication situation is degraded of the communication environment.

4. The communications apparatus according to claim 1, wherein:
said change in the communication situation is amelioration of the communication environment.

5. The communications apparatus according to claim 1, further comprising:
a link database for storing link information required to establish a link between said communications apparatus and another communications apparatus on said network; and
a device database for storing device information on each communications device on said network, classified according to available communication standards.

6. A communications system having a network which is built using a plurality of the communications apparatuses according to claim 1.

7. A method of communicating between devices in a network made up of a plurality of said devices, each capable of a multi-hop communication conforming to at least one wired communication standards or wireless communication standards, wherein:
said device monitors a communication situation on communication links and path established between said device and a destination device; and
when the communication situation changes, said device switches the communication path for use in a communication with the destination device to another communication path which can be established between said device and said destination device.

8. The communication method according to claim 7, wherein:
said change in the communication situation is new traffic generated on a communication path established between said device and said destination.

9. The communication method according to claim 7, wherein:
said change in the communication situation is a degradation of the communication environment.

10. The communication method according to claim 7, wherein:
said change in the communication situation is amelioration of the communication environment.
